(19) United States
(12) Patent Application Publication
(10) Pub. No.: US 2021/0154079 A1
(43) Pub. Date: May 27, 2021

(54) SYSTEM FOR CREATING ARTIFICIAL GRAVITY

(71) Applicant: Shyam Chandra DAS, Saratoga, CA (US)

(72) Inventor: Shyam Chandra DAS, Saratoga, CA (US)

(21) Appl. No.: 16/953,302

(22) Filed: Nov. 19, 2020

Related U.S. Application Data
(60) Provisional application No. 62/938,689, filed on Nov. 21, 2019.

(51) Int. Cl. A61H 1/02; H01F 7/20; H01F 27/24; B64G 1/46

(52) U.S. Cl. CPC A61H 1/0229; H01F 7/202; A63B 22/02; B64G 1/46; A61H 2201/1207; H01F 27/24

(57) ABSTRACT

Lack of gravity is a cause of major health concerns for astronauts travelling or living in space. The systems, in accordance with the embodiments of the invention, provide Artificial Gravity. The users or subjects experience Artificial Gravity while exercising in an environment without gravity, such as space. Another embodiment includes chambers shielded by multilayer magnetic toroid and multilayer soft magnetic layered clothing that shields astronauts from radiation and stray magnetic fields while providing a gravitational (artificial gravity) effect.

### CROSS REFERENCE TO RELATED APPLICATIONS

This application claims the benefit of U.S. Provisional Application Ser. No. 62/938,689 titled ARTIFICIAL GRAVITY USING PRESSURE AND FIELDS filed on Nov. 21, 2019 by Shyam Chandra DAS, the entire disclosure of which is incorporated herein by reference.

### FIELD OF THE INVENTION

The invention relates to use of an apparatus for solving health problems and more specifically to solving health problem caused by the lack of gravity during space habitation, travel; and radiation damage.

### BACKGROUND

The human body evolved to function under earth's gravity. The cardiovascular system has evolved to push blood against gravity. Therefore, without gravity, blood is not properly distributed. For example, blood pools in the upper part of the body. Blood flow can stop, reverse and clot in the upper parts of the body. The blood accumulates in the chest and head, making swollen veins and a puffy face (fluid shift). As a result, astronauts' waistline and legs become substantially slimmer. Butt and legs also become hypersensitive to touch. Since the heart does not have to work hard in the absence of gravity, the body eventually compensates by weakening the heart muscles. Another potential ill effect of low gravity is the make-up of gut bacteria changes which could have adverse effects on immune system health.

Astronauts go into space orbiting the earth at high speed. Centrifugal force from rotation around the earth balances the gravitational pull of the earth keeping the space craft in orbit. The gravity induced free fall to earth balanced by the centrifugal force of being in orbit makes astronauts weightless in the space. This weightlessness is called microgravity. For example, the International Space Station (ISS) orbits around the earth at about 17,000 mph at 254 miles above earth. The astronauts aboard the ISS live in a constant microgravity environment. Astronauts on the ISS experience several debilitating effects caused by living in microgravity for several months.

Microgravity causes astronauts to suffer from any combination of, or all the following adverse effects:

Loss of bone and muscle mass of about 1% per month.

Far more increase of calcium in their urine than on the earth (indicating bone loss).

Atrophy of muscles (calf, quadriceps, back, neck), which maintain a balanced upright posture.

Fat accumulation and tendonitis.

Back ache caused by separation of Vertebrae by about 2 inches and weakening of back muscles.

Risk of high blood pressure

Thickening and stiffening of blood vessel walls, increasing cardiac stroke volume, which may predispose astronauts to cardiovascular disease.

Visual impairment and increase of pressure in their brains.

Narrowing of the grooves at the top of the brain (central sulcus)

Shifting of the brain upwards in the skull.

Deterioration of organ function and cardiac arrhythmia.

Changes in immune system including impaired T-cells.

Blood flow stops, even reverses and/or blood clots form in the upper part of the body

A counter measure to the negative health effects of microgravity is a minimum of two hours of exercise every day. The two-hour exercise regimen constitutes a combination of bicycling, restrained treadmill running and vacuum generated isometric exercises (weight-lifting machine strapped to the wall). Even with two hours of exercise each day, astronauts still lose bone and muscle density of approximately 1% per month plus the other deleterious health effects mentioned above. More particularly, blood flow is reduced to the arms and legs. Bodily fluid shifts to upper part of the body causing vision problems. These are all due to a microgravity environment.

Approximately 300 entities including private companies and Government agencies around the world are making space travel a priority. Their goal is to move to deep space, with permanent lunar stations, Mars colonies, space tourism and space hotels.

For example, NASA announced the commercial use of space and thirty-day trips into space for private astronauts and private tourism aboard ISS. The founder of Blue Origin, Jeff Bezos, is ambitious to build a space colony to which earth's polluting industries can be moved so the earth can become environmentally clean. That endeavor alone will require a large human workforce to live in a microgravity environment for extended periods of time. Morgan Stanley estimates space travel will grow into an industry worth more than $1.1 trillion by 2040.

One example is the long talked about trip to Mars. After about nine months travelling to Mars, people will experience all the deleterious health effects caused by living in microgravity. Another example is the colonization of Mars or the Moon. In either case, human space colonizers will live in a hypo-gravity (reduced gravity) environment for a long time. Mars has about ⅓^{rd} of earth's gravity, and the Moon ⅙^{th} the gravity found on earth. Longer stays in hypo-gravity and microgravity due to space travel and exploration requires improved exercise techniques. One such idea is to utilize a swimming chamber.

Long periods in microgravity without a shower is an uncomfortable reality for astronauts. With extended periods of isolation in microgravity astronauts may develop psychological problems as well. Therefore, what is needed is an apparatus that addresses issues caused by microgravity through means of entertainment and exercise.

Galactic Cosmic Rays (GCR) and solar radiation including solar flares (all together referred as “radiation”) have very high energy ions from hydrogen to iron ions. They are dangerous to any living cells in humans, plants or animals. There have been various attempts to shield astronauts from the radiation using various means, including magnets. But there has been no successful technique to do so; because active magnetic shields contain excessive mass and astronauts using them are exposed to high magnetic fields.

### SUMMARY OF THE INVENTION

The invention includes an apparatus that addresses issues caused by gravity changes through means of exercise and radiation protection in an enclosure. In accordance with various aspects and embodiments of the invention, disclosed are various aspects and embodiments of Artificial Gravity (AG) exercise apparatus to combat the physical, and emotional effects of the lack of gravity; and two embodiments providing radiation protection in space. The various embodiments are apparatus that use:

AG generated using differential pressure;

AG generated using a magnetic field;

A toroid swimming pool with AG generated using differential pressure with fluid;

A toroid swimming pool with AG generated using differential pressure with fluid and a magnetic field;

AG toroid running track without fluid and using a magnetic field;

AG treadmill using a magnetic field.

Magnetic enclosure with soft magnetic material suit to shield from radiation.

Radiation Shield for spaces.

### BRIEF DESCRIPTION OF THE DRAWINGS

The invention is described in accordance with various aspects and embodiments in the following description with reference to the figures (FIG.), in which like numbers represent the same or similar elements.

FIG. 1 illustrates a swimmer swimming in a fluid in a pressure gradient in accordance with various aspects and embodiments of the invention

FIG. 2 illustrates a swimmer swimming in fluid in a pressure gradient within a toroid shaped pool in accordance with various aspects and embodiments of the invention.

FIG. 3 illustrates a swimmer swimming in fluid in a pressure gradient within a continuous flow pool in accordance with various aspects and embodiment of the invention.

FIG. 4 illustrates a swimmer swimming in fluid within a rotating spherical or cylindrical shaped pool in accordance with various aspects and embodiments of the invention.

FIG. 5 illustrates a swimmer swimming within a magnetic field in fluid in Artificial Gravity generated by a toroid magnetic field within a toroid shaped pool wearing a perm-alloy whole-body swimming suit in accordance with various aspects and embodiments of the invention.

FIG. 6 illustrates a runner running within a magnetic field in a liquid free toroid shaped running track wearing a permalloy running suit in accordance with various aspects and embodiments of the invention.

FIG. 7 illustrates a runner running within a magnetic field on a treadmill in a partial toroid-shaped magnetic chamber wearing a perm-alloy complete body running suit in accordance with various aspects and embodiments of the invention.

FIG. 8 illustrates a space traveler walking up a stair climber within a partial toroid shaped magnetic chamber wearing a perm-alloy complete body running suit in accordance with various aspects and embodiments of the invention.

FIG. 9 illustrates the fabric weave of permalloy or other soft magnetic material clothing in accordance with various aspects and embodiments of the invention.

FIG. 10A illustrates a radiation shield that also provides Artificial Gravity in accordance with various aspects and embodiments of the invention.

FIG. 10B illustrates a sectional view of FIG. 10A

FIG. 11 illustrates a continuous double toroid running track in accordance with various aspects and embodiments of the invention

FIG. 12 defines the parameters used in calculation of force on magnetic material when in a magnetic field in a toroid in accordance with various aspects and embodiments of the invention.

### DETAILED DESCRIPTION

Reference throughout this specification to “one embodiment,” “an embodiment,” or similar language means that a particular feature, structure, or characteristic described in connection with the various aspects and embodiments are included in at least one embodiment of the invention. Thus, appearances of the phrases “in one embodiment,” “in an embodiment,” “in certain embodiments,” and similar language throughout this specification refer to the various aspects and embodiments of the invention. It is noted that, as used in this description, the singular forms “a,” “an” and “the” include plural referents, unless the context clearly dictates otherwise.

The described features, structures, or characteristics of the invention may be combined in any suitable manner in accordance with the aspects and one or more embodiments of the invention. In the following description, numerous specific details are recited to provide an understanding of various embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring the aspects of the invention.

Artificial Gravity (AG) using differential pressure: Swimming may help to reduce the deleterious effects of microgravity and psychological isolation stress by providing another means of exercise and entertainment. But in microgravity fluid will float. Therefore, a swimming pool in microgravity must be pressurized above the ambient pressure to hold the fluid in its place. To pressurize the fluid, the fluid must be enclosed.

Because of microgravity the buoyancy of fluid disappears. Therefore, in microgravity, there will not be a buoyancy force pushing the body upwards nor will the body sink in the fluid due to gravity. In microgravity there is no up and no down. But you could swim in fluid in the direction one propels him/herself. However, directional flow of liquid can break the symmetry in fluid in microgravity.

The liquid resistance of fluid increases as one swims faster. On the earth if you lift your hands, you are lifting your arms against gravity. But in microgravity there is no force of gravity acting on the body. While swimming in microgravity, the swimmer lifts her/his hands against the friction (viscosity) of the fluid and splashes against the cohesive force of fluid. The faster a swimmer swims, the larger the frictional force he/she creates.

For a human 6 feet tall, 2 feet wide and 5 inches deep, weighing 170 lbs. the surface area of the person swimming (in supine position) is about 1500 to 3000 square inches. The gravitational force acting on the body=170 lb*32.2 ft/sec²=65688 lb·in/sec².

Therefore, gravitational pressure, the force pulling downward per square inch of body area, pound per square inch (psi) on the body:

=65688 lb·in/sec2* 1/2000 in2=33 lb./in. sec2.1/32.2 ft/sec2 1 lb/12 inch2=0.1 psi, considering the person is sleeping, supine or swimming. This is less than 1 psi pressure on the earth.

Therefore, applying 2 psi of dynamic pressure above the ambient pressure in the enclosed pool in microgravity, the total pushing force on the body will be more than the gravitational pressure on the body on earth. Two psi dynamic pressure in the endless swimming pool can be maintained without danger in an ordinary pressure vessel. A garden hose on earth holds about 80 psi of water pressure. The person swimming in a 2-psi dynamic pressurized endless swimming pool will have the full gravitational effect that a person experiences on earth.

The viscosity of the fluid (water or other highly viscous fluid) will act against the muscles and joints while the person is swimming. Joints working under force will reduce tendonitis issues. The stronger the movement of feet and arms against the liquid, the more the activation of muscles, bones, and joints. The blood rushes to the active muscles. Since all the muscles will be active during swimming in water or other viscous liquid under dynamic pressure, the blood will rush to all the muscles thereby minimizing the fluid shift due to the microgravity environment. Swimming in pressurized fluid will strengthen muscles, bones and joints while minimizing the body's fluid shift experienced in microgravity. Swimming in the pressurized swimming pool in the International Space Station (ISS) (or other space environment) will use every part of the body against pressure or viscous force as if the swimmer were swimming on earth. This will reduce fluid shift in the human body and other deleterious health effects of microgravity and provide all the advantages of swimming on earth, including proper blood flow to organs, muscles, and bones.

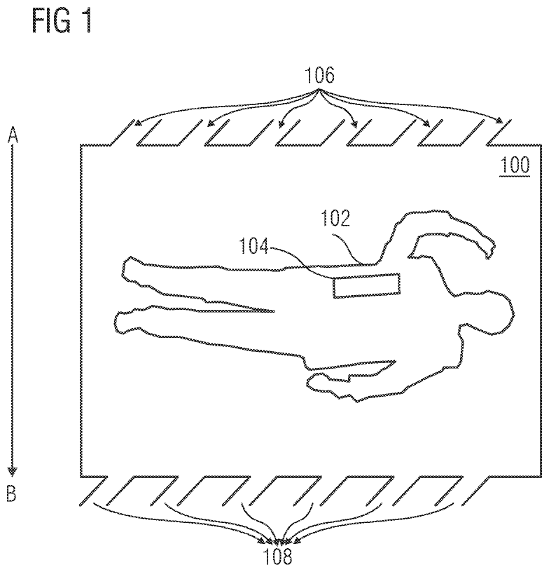

Now referring to FIG. 1, where pressurized fluid is pumped into the swimming chamber on side A at an angle, preferably 45°, through input channels 106, and evacuated from the swimming chamber on its opposite side B, through outflow channels 108 at the same angle so that the swimmer experiences horizontal and vertical components of flow pressure. The directional symmetry of microgravity is broken due to direction of the pressure. The lower pressure direction of the fluid near side B can be considered down and the higher-pressure direction of the fluid near side A can be considered as up.

The swimming chamber will be pressure controlled at the desired pressure to simulate earth's gravity or any other desired pressure by the controlled flow of the pressurized fluid from the input channels 106 to the outflow channels 108. While in the swimming chamber, a swimmer 102 with a breathing device 104 will be swimming within a pressurized fluid 100, with dynamic pressure on his/her body. Replacement of gravity by applied pressure and swimming against the viscosity of the fluid 100 will minimize muscle loss, bone loss and fluid shift. In other words, the deleterious effects of microgravity will be significantly minimized.

Because of the limitation of space inside the spacecraft, forward or horizontal, swimming must be balanced by an opposing flow 106 to 108 of fluid 100 to make the swimmer 102 stationary with respect to the vessel containing the fluid 100.

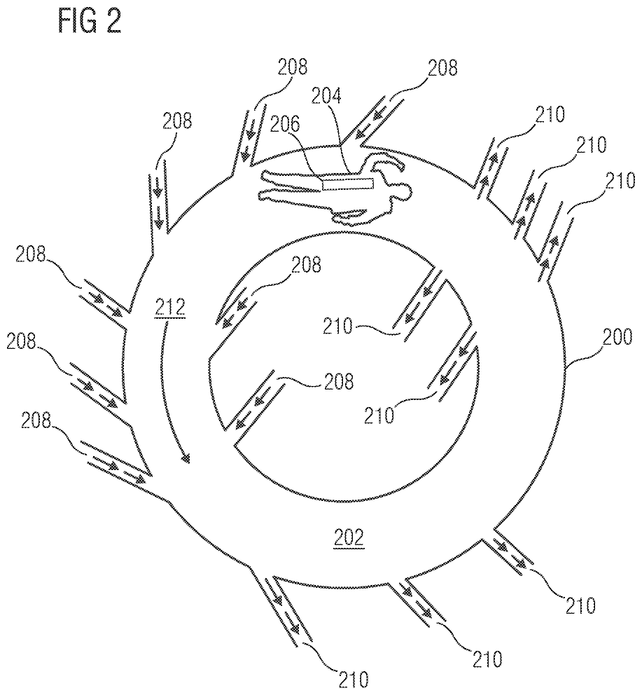

Referring now to FIG. 2, in accordance with various aspects and embodiments of the invention, if the swimming chamber 200 is toroidal in shape, the fluid, 202, can be forced into the chamber at different circumferential points 208 to create the desired differential pressure and fluid circulation. For a toroidal shaped chamber, 200, the fluid can be injected into the chamber at the inner and outer circumferences, 208, and can be sucked out of the chamber at a downstream portion of the inner and outer circumferences, 210. The circular symmetry of a toroid or sphere will create circular motion of the fluid due to angular differential pressure, giving rise to angular velocity ω to fluid flow. If the radius of the toroid is R, the artificial gravity experienced by the person 204 swimming in the fluid will be ω²R. Therefore, the fluid motion and the radius can be adjusted to create the desired artificial gravity. If the swimmer 204 with a breathing device 206 swims in the direction of circulation of fluid, that will increase ω. But if the swimmer 204 swims against the circulation, that will decrease ω, but the swimmer will face larger resistance against the flow of fluid.

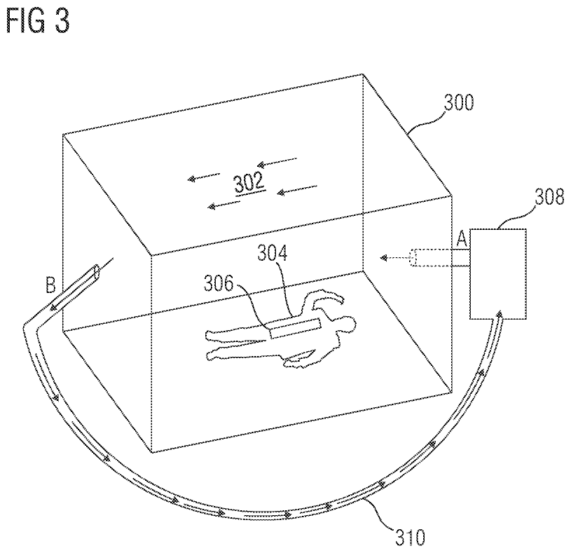

Referring now to FIG. 3, in accordance with various aspects and embodiments of the invention, the swimmer 304 with a breathing device 306 will swim against the flow pressure of the fluid that is being pumped from A to B within and enclosed swimming chamber 300. The fluid would then be circulated back to the pump 308 by means of a conduit 310. The flow of fluid can be maintained by a circulating pump 308. The horizontal flow of the fluid 302 will be against the forward movement of the swimmer 304, creating an AG effect on the swimmer 304. The swimming vessel 300 could be cube shaped, like an endless swimming pool on the earth. The swimming chamber could be any other shape.

The directional pressure 302 can be maintained by a circulating pump 308 creating a flow of fluid to produce the desired differential pressure. The fluid pressure can be distributed evenly with the help of a perforated lid or pressure actuator. The fluid pressure can be constant pressure or a continuous flow of fluid to create the pressure gradient. If a continuous pressure gradient is desired, the fluid could be continuously circulated through a pump to maintain the desired differential pressure.

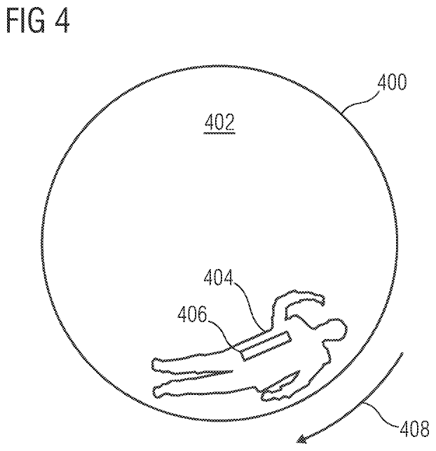

Now referring to FIG. 4, a rotating symmetric shape, like a spherical or a cylindrical or toroidal shaped swimming chamber 400 can be rotated at a comfortable speed 408 to provide centrifugal force to the fluid inside 402 to simulate extra artificial gravity to the swimmer 404. The rotation of a circular symmetric vessel can be accomplished through a ball and socket arrangement or a gear mechanism along the rotational axis without any axel to provide continuous fluid 402 flow for swimming anywhere inside the vessel. Since all astronauts must qualify as scuba divers and have to practice Extra Vehicular Activity training in the neutral buoyancy swimming pool on earth, they are comfortable to swim under fluid with a breathing device 406.

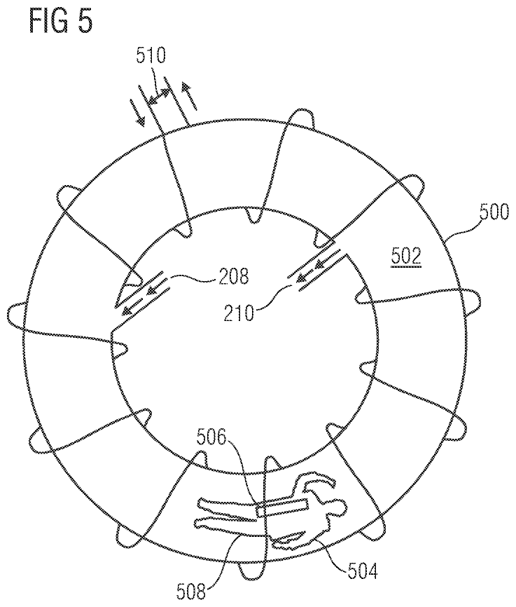

Now referring to FIG. 5 and FIG. 2, another approach to creating artificial gravity for exercise in space is to use a swimming chamber in which swimmers 504 use a breathing device 506 and wear a complete body swimsuits 508 impregnated with a thin layer of perm-alloy fabric or any other soft magnetic fabric. The swimmer swims within a pressurized fluid 502 permeated by a magnetic field. The swimming pool can be a toroid shaped tube 500 with a 4-foot inner radius and an 8-foot outer radius, wound with wire 510 to create a magnetic field within the toroid shaped tube. To create an additional AG effect, fluid 502 will be pumped into 208 the swimming chamber and one location along its circumference and pumped out 210 of the chamber at another location around its circumference.

The magnetic field calculations can be done by magnetic modeling simulation. To illustrate the principle, assumptions based on the principles of Physics are used to understand the concept and its applicability. Let us consider the swimming astronaut in a permalloy deposited complete body swimsuit is a rectangular box with sides L, W, and perm-alloy deposited thickness dw. Volume v for permalloy, V=L·W·dw. Consider a deposited perm-alloy thickness of, dw=100μ=10⁻⁴ m.

The magnetic field H inside the toroid is inhomogeneous (unlike a solenoid). The permalloy shell on the box will experience a force inside the toroid towards the radial direction or any direction where there is inhomogeneous field B=μH, μ is relative permeability for permalloy

If F is the force acting on permalloy coated box, based on principles of Physics

Force F∞v, volume of permalloy, so long as permalloy is in the linear range (did not saturate or not more extra volume of permalloy)

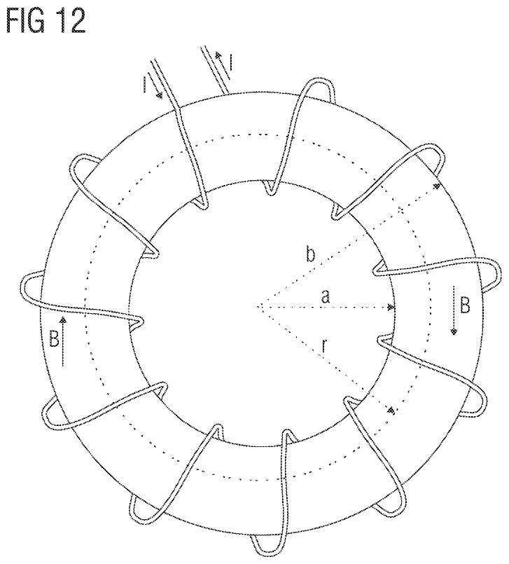

Now referring to FIG. 12, which illustrates the parameters used in the following calculation:

F∞B_{z}, the circumferential (B) field of the toroid

F∞dB_{z}/dr, field gradient in the radial direction of the toroid.

F∞v·B_{z}·dB_{z}/dr, or

F=c v·B_{z}·dB_{z}/dr, c is constant depending upon unit used

For MKS unit, v=m/s, B_{z}=T(Tesla), dB_{z}/dr=T/m, T=N (Newton)/A·m

Then c=1/μ₀,

μ₀=4π10⁻⁷=1.26 10⁻⁶=1.26E-6 Newton/Amp²

F=1/μ₀·v·B_{z}·dB_{z}/dr Newton

Comparing the above formula with a numerical calculation of an iron cylinder at the end of a solenoid (where field is inhomogeneous). That checks out within a factor of 1.5. Therefore, we will calculate force on the permalloy box shell using this formula to understand the effect:

B_{z}=μᵣμ₀ NI/2πr For a Toroid

Size of toroid is limited by the rocket faring size. The Starship fairing diameter is 30′.

For example, consider a toroid, parameters consistent with FIG. 12:

a=6′

b=10′

This force formula will give an idea and feasibility of artificial gravity creation in a toroidal swimming pool. For a toroid:

a=6′

b=10′

1000 turns wound with 15-gauge copper wire flowing 1 Amps current the force on the box L=4′=1.21 m, W=1′=0.31 m, skin thickness of permalloy dw=10⁻⁴ m, are as follows:

At r=a=6′=1.83 m, the innermost radius of the toroid.

F=31 Newton, equivalent to gravity force acting on mass 3.2 kg on the Earth

At r=8′=2.44 m, the central radius

F=13.8 Newton, equivalent to gravity force acting on mass 1.41 kg

At r=b=10′=3.1 m, at the outermost radius of the toroid

F=9.9 Newton, equivalent to gravity force acting on mass 1 kg

If we use 15-gauge wire for winding. Wire diameter=0.072″

Will take space for 1000 turns=72″/12=6′. i.e., inner radius=6′ will accommodate 1000 turns in one-layer winding of the toroid.

Therefore, for the toroid: a=6′ and b=10′ The force acting on a box with permalloy shell (permalloy plating thickness on the swimsuit) 100μ=10⁻⁴ m around the box 4′ long and 1′ wide (representation of human) changes from 3 kg mass weight to 1 kg mass weight equivalent on the earth. This is 3 times force variation from innermost radius to outermost radius of the toroid.

Since there is no buoyancy in microgravity, the astronauts will feel the lightest AG effect at the outermost radius and strongest AG effect will be felt at the innermost radius of the toroid shaped swimming chamber. That means, the astronauts in the innermost radius of the toroid will have to swim harder to move to the outermost radius of the toroid.

Using a 15-gauge wire for winding to carry 1 Amp current and 1000 turn to generate about a 1 Tesla field inside permalloy shell (outside permalloy but inside the toroid about 1×10⁻⁴ Tesla). The high permeability permalloy or any other soft magnetic material which does not saturate. If it saturates, reducing the current in the toroid to make the suit unsaturated will completely shield the human from any stray magnetic field outside the suit. If the magnetic field outside permalloy suit is much higher causing the permalloy suit to be saturated, there can be another magnetic shield outside the permalloy suit made of higher saturation magnetization material that barely saturates from the current in the coil. Thus, the leaked field from the barely saturated outer shield is just enough not to saturate the permalloy suit. If needed, there can be multilayer soft magnetic shields of different successive saturation levels outside the permalloy suit that keeps the permalloy suit unsaturated and acts like a magnetic shield. This duel (or multilayer) magnetic shield will protect the astronaut fully from the magnetic field in the toroid, while the suit combination will allow the swimmer to experience an artificial gravity force.

Resistance of 15-gauge wire=6.56 Ω/km

Weight of wire=0.0157 lb./ft or 0.0234 kg/m

The radius of toroid tube=2′=0.61 m

Circumference of the toroid=2πr=11.5m, central r=6′=1.83m

Circumference of 1 turn around the tube=2π×0.61m=3.833m

Total length of the wire used=3.833×1000=3833m

Total Weight of wire windings=3833m×0.0234 kg/m=90 kg

Total Resistance of wire used=6.56 Ω/km×3.833 km=25Ω

Power dissipated in the windings=12×25=25 watts

If necessary, use water jacket around wire windings as heat exchanger, which can be fed back into the toroidal pool to keep the water warm.

Central circumference of the toroidal tube=2π·8′=50′=15.3 m

Volume of water in the toroid=π·0.61²0.15.3 cubic m=17.9 m³

1 m³=10³ liter

Consider Volume of water in the toroid=20,000 liter

Weight of water in the toroid=20,000 kg=20 tons

NASA is building Gateway in the cislunar orbit.

This water can be acquired from frozen water ice on the Moon to the Gateway.

Because the Moon's gravity is ⅙^{th} that of earth gravity, it will be much easier to lift water from the Moon than from the Earth.

This illustration shows that the toroidal swimming pool concept with astronauts wearing a permalloy deposited swimsuit can create artificial gravity using a magnetic field generated in the toroid.

Alternatively, the artificial gravity by toroidal field can also be created without water in the toroid. If lifting 20 tons of water from the earth or the moon is not practical, a toroidal running track can be made without water in it.

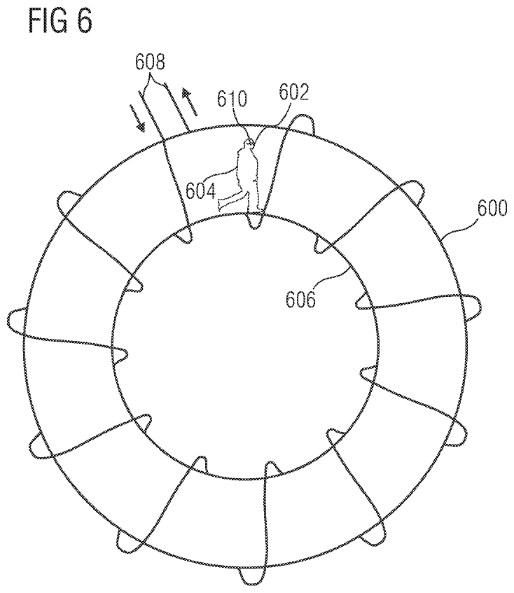

Now referring to FIG. 6, according to various aspects and embodiments of the invention, a toroidal running track 600 wound by an electrically charged wire 608 that creates a magnetic field within the toroidal track. Assume we have a toroid 600 without fluid in it. The diameter of the toroid tube must be at least 7′. Consider a rectangular shape tube with a height of 7′ to accommodate a 6-foot 6-inch person to stand, walk and run within the tube. The width of the rectangular tube is at least 6 feet to accommodate two people walking or running in opposite directions or walking together moving in one direction. Since the tube is a toroid 600 with its two ends connected, it makes a continuous circular running track. The rectangular tube becomes a rectangular shape toroid:

L=7′=2.13m

W=3′=0.91m

This rectangular shape toroid has again

a=6′

b=6′+7′=13′=4 m

At r=a=6′, the foot of the runner, there will be maximum force pulling the feet down and the force will decrease towards the head of the jogger. The current in the wire coil 608, number of turns in the coil 608 and active permalloy volume (experiencing the force from the magnetic field) can be adjusted to create appropriate artificial gravity. For a=6′ toroidal rectangular running track, the circumference of the toroid is about 38 feet. That means, the jogger 604 will run around the inner circumference 606 of the toroid running track 600 at about a degree or rotation per six inches of running. This may make the runner dizzy. For the runner to feel comfortable, the inner diameter of the toroid must be increased, which may become larger than the faring of the spacecraft.

If we use Bigelow expandable habitat (BEAM: https://www.space.com/19297-inflatable-space-stations-bigelow-aerospace-infographic.html) that can expand to a maximum diameter of 60 feet then we can make a toroidal running tack length=πd=π·60·189′.

Since the runner 602 with permalloy suit 604 will cover about 6 inches per degree of rotation. This will reduce dizziness while running on the circular track. For entertainment, the walls of the track may have a continuous moving display as if the person is running in a specific city or in natural on earth. That will be entertaining and less stressful for the runner. Since the runner may use Virtual Reality goggles 610 and can experience entertainment while running, he/she may feel less isolated in lonely environment of space.

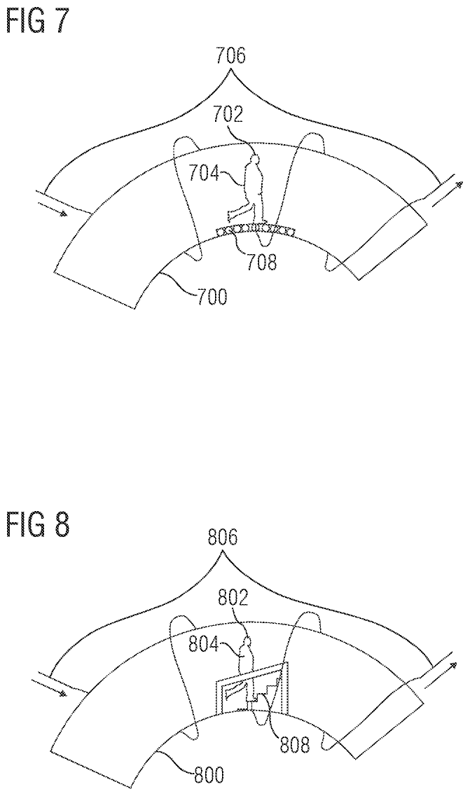

Now referring to FIG. 7, according to various aspects and embodiments of the invention, it shows a segment of the toroidal running track 700 used by an astronaut 702 wearing a permalloy suit 704, running on a treadmill. The partial toroidal treadmill running track 700 will be a segment of a full toroidal running track with all the benefits of the full toroidal track and without utilization of a large space and without the runner getting dizzy. The difference between toroidal treadmill 708 and regular treadmill is that, the toroidal treadmill has wire 706 wound around the rectangular casing around a treadmill to create an inhomogeneous magnetic field inside the casing to create artificial gravity. The astronaut runner 702 wearing a permalloy or other soft magnetic material whole body suit 704 runs in the inhomogeneous magnetic field generated by the coil windings 706, thus experiencing Artificial Gravity.

These AG creating techniques can also be used on earth for improving sports stamina, sports training, exercise for handicapped individuals, recreation, and many other applications.

To illustrate the partial toroidal running treadmill 700, Consider the treadmill is shaped like an upward bowed walk bridge over a creek. A walk bridge has walls on both sides and a ceiling on the top. This makes a tunnel over the upward bowed (convex) walking bridge. The walk bridge, partial toroidal, tunnel is wound with wire 706 to create a toroid magnetic field within the partial toroid 700. The sidewalls of the walk bridge have a movie running, simulating any crowded street (or any other scene) of a city on the earth (earth simulation through VR). The treadmill running surface is made of stripes on rollers 708. When the runner 704 lifts the knee and pounds on the stripes with his/her heel at an angle, the stripes move backward with the impact of the heel giving a sense of moving forward (similar to a treadmill exercise machine on earth) while the person is stationary with respect to the walls. The movie running on the walls or in VR goggles gives a feeling of running in a crowded place or VR simulation with a desired companion on the earth.

The partial toroidal running treadmill enclosure should be curved upward (convex) (opposite the curvature of Woodway™ or Truerunner™ treadmill, which are concave). The treadmill 708 will be curved, like part of a toroid. In contrast, a straight treadmill (solenoid winding) would produce a homogeneous field, but a partial toroid shaped treadmill produces an inhomogeneous magnetic field. An inhomogeneous magnetic field is required for a gravity-like force to act upon a runner in a permalloy suit.

Now referring to FIG. 8, according to various aspects and embodiments of the invention, another version of a partial toroid 800 exercise chamber can include a stair climber 808 or any other exercise system. The partial toroid chamber 800 will include wire windings 806 to produce an inhomogeneous magnetic field within the partial toroid 800. The inhomogeneous magnetic field will have an AG effect on an astronaut 802 wearing a permalloy or other soft magnetic material exercise suit 804. The stair climber 808 can be motorized or nonmotorized (manual). The stair steps will go down as the climber 802 impacts the manual stair steps while the resistance of stair turning movement can be adjusted through frictional force.

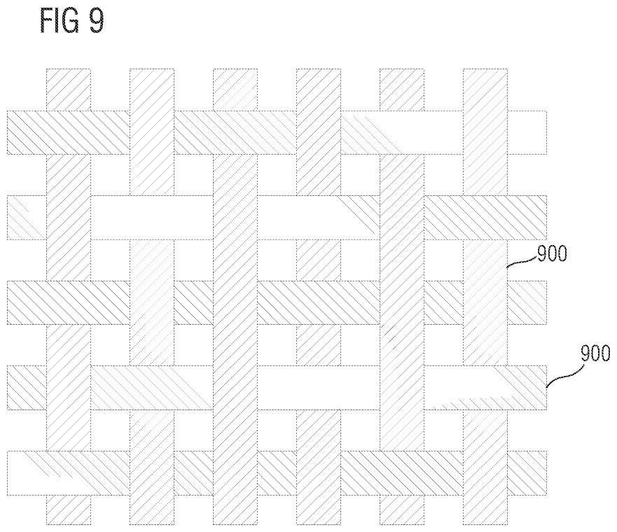

Now referring to FIG. 9, according to various aspects and embodiments of the invention, a soft magnetic material 900 coated complete body swimsuit or running suit or other clothing can be made from a continuous permalloy coated plastic (e.g., Mylar) or any soft magnetic material coated fabric, including cotton. Threads of the fabrics could be permalloy or permalloy impregnated (or any soft magnetic material) or coated fabrics of cotton, nylon, Luon etc. or any combination thereof. A soft magnetic material (steel, mu-metal, permalloy etc.) coated (or impregnated) clothes from which clothing can be made.

If permalloy gets saturated with higher magnetic fields required for the desired artificial gravity, there can be another garment containing a higher concentration of permalloy or other soft magnetic material 900 worn on the outside of the permalloy suit. The outer magnetic garment would not become completely saturated by magnetic fields generated by the exercise apparatuses shown in FIGS. 5, 6, 7, 8, 10A, and 11.

Successive layers of garments composed of permalloy of other soft magnetic material 900 can be worn by astronauts to protect them from harmful, strong magnetic fields. This double (or multilayer) shield may create sufficient artificial gravity force while also shielding the human from exposure to harmful magnetic fields.

Another embodiment of a soft magnetic material 900 suit is to create a weightless situation under the earth's gravity. NASA's Neutral Buoyancy Lab (NBL) is large, 10 Olympic swimming pool combined. NBL offers the best available analog to working in space. NASA spends multimillion dollars a year to maintain it. Using a permalloy suit will create a better analog of working in space than NBL. Astronauts practice EVA in NBL. But that is in water and viscosity of water will interfere with free space activity. But permalloy (or soft magnetic material) suit will create the best condition of microgravity in free space. For that, consider a ceiling made of a magnet (or electromagnet). A person in permalloy suit will be attracted to the ceiling. Now adjust the magnetic force pulling up to the ceiling equal to the gravity force down. That balance of force will create weightlessness of free space. If needed, there can be another electromagnet on the floor (that may repel a magnet if attached to the feet). The ceiling and the floor electromagnets can be adjusted to get a desired band of neutral, gravity free zone. This weightlessness will be very attractive for recreation on the earth to simulate the microgravity of space on the earth. Presently, a very expensive technique of parabolic flight (vomit comet) or jet is used to create weightlessness only for 20 seconds without going to space. https://www.gozerog.com/charges over $5000 per person for recreation.

Another embodiment of permalloy suit will be to divert the charged particles from the solar radiation and Galactic Cosmic Rays (GCR) entering the enclosure during space travel. Radiation is a serious problem during space travel or on Moon or on Mars.

If we have an enclosure (cubical) with ceiling and floor made of magnets (or electromagnets): South-North-South-North polarity (or magnetic material cylinders, or any other shape, and wire wound around the outer magnetic cylinder to fully magnetize the walls of cylinder), the person in that enclosure wearing a permalloy suit will be protected from damaging charged energetic particle radiation; because of diversion of charged particles by a magnetic field in the magnetic enclosure. Further, the charged particles outside the cylinder will not penetrate inside the suit because of 10⁴ times (than outside the suit) higher magnetic field within the permalloy suit due to high permeability (10⁴) of permalloy. Human cells will be protected from the damaging radiation, which will be shielded by the magnetic field inside the magnetic permeable suit. Since the magnetic field will permeate only inside the permalloy suit, the human tissues will not experience the magnetic field from the magnet (stray field) when the permalloy suit is not saturated. If a stronger magnetic field is required to divert the energetic charged particles and if permalloy gets saturated with that higher field, there can be another enclosure of higher saturation magnetization outside the permalloy suit in the magnetic field that the outer enclosure of the suit does not saturate. This higher saturation magnetization may be cylindrical (or any other desired shape, including another layer on the suit). The high saturation magnetization material outside the permalloy suit will be the major shield, reducing the magnetic field on the permalloy suit below the saturation of permalloy. This double (or multiple) shielding will protect astronauts from the damaging radiation and stray magnetic fields by shielding magnetic fields and charged particles through unsaturated permalloy and protecting the human from the magnetic field and radiation damage.

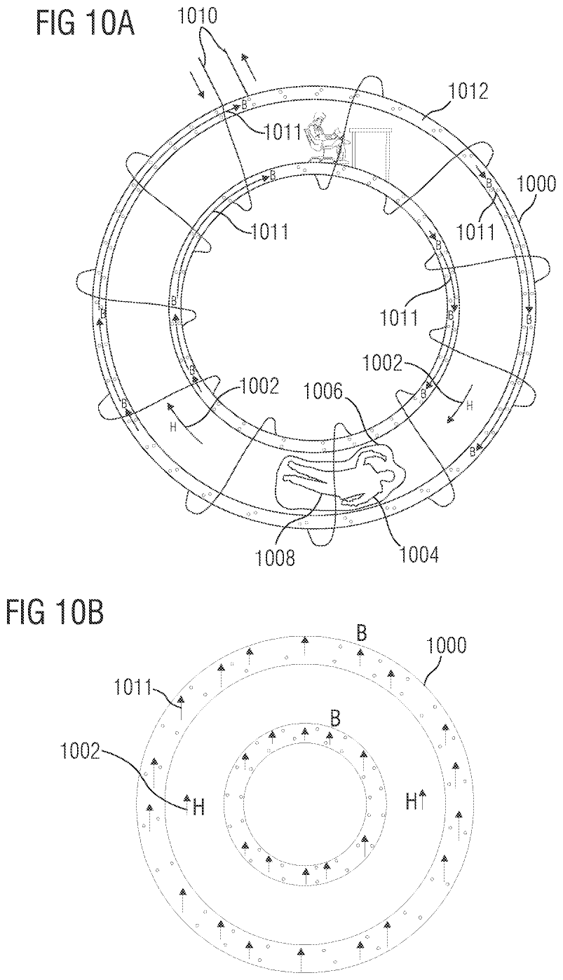

Now referring to FIG. 10A, according to various aspects and embodiments of the invention, it shows a type of cubical or living space with double (or multiple) shielding if required, within a magnetic enclosure can become a place for astronauts in permalloy (or any desired soft magnetic material) impregnated suit or sleeping bag to work or sleep in this magnetically shielded area in the radiation free environment as well as provide artificial gravity force due to pull on permalloy suit or permalloy impregnated sleeping bag.

Wire 1010 is wound around a toroid 1000 made of magnetic material 1012. For example, consider 1012 as steel, which saturates around 2 Tesla. Magnetic field B, 1011, located within the thickness of the toroidal magnetic shell 1012 (made of steel or other magnetic material) will be about 2 Tesla. The toroid 1000 fits in the fairing of the spacecraft. Some of the magnetic field, H 1002, leaks inside the living space when a magnetic field generated by the coil is above saturation of the magnetic toroidal shell 1012. The leaked field is just enough to saturate a permalloy (or multilayer permalloy) sleeping bag or suit 1008 that an astronaut 1004 is wearing. This arrangement will shield the astronaut from radiation, stray magnetic fields, and provide artificial gravity.

Now referring to FIGS. 10B, and 10A, according to various aspects and embodiments of the invention, FIG. 10B is the cross-sectional view of FIG. 10A where the toroid 1000 has magnetic field B 1011 located in its outer and inner shells, and stray magnetic field H located within the living space.

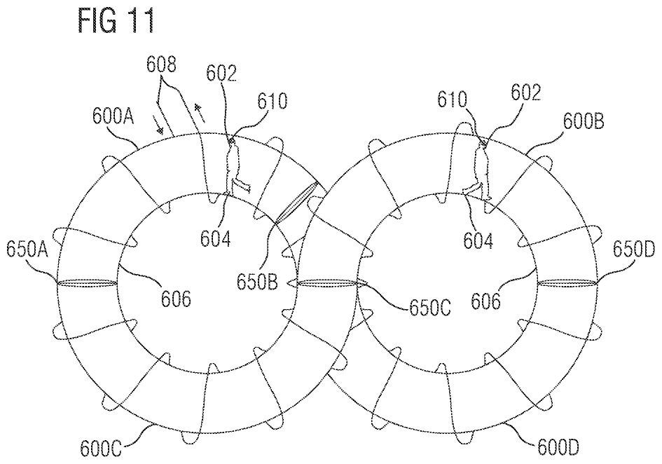

Now referring to FIG. 11, according to various aspects and embodiments of the invention, represents a continuous running track created by joining four half toroids in the following manner: one on top 600A and another on bottom 600D are joined at 650B. Now the free end of 600D is joined with another half-toroid 600B at 650D. The free end of 600B is connected to another down half-toroid 600C at 650C. The free end of 600C in turn connects with 600A at 650A. This makes the continuous running track. Electric current in the coil through the leads 608 generates an inhomogeneous magnetic field within the toroid. The runner 602 with VR goggle 610 and Permalloy suit 604 runs on the inner radius 606 of the toroid. The magnetic AG force pull is highest on the inner radius 606 and reduces when the runner 602 runs towards the outer radius. Let us suppose the runner starts running at inner radius 606 of the section 600A. When the runner crosses 650, the inner radius of 600A and 600C, he comes to the outer radius of 600B. When the runner reaches 650C he or she starts running on the outer radius of 600B, the person will feel lighter due to reduced magnetic force generated AG on the outer radius. As the person feels reduced pull, he or she moves to inner radius 606 of the half-toroid 600B. Again, at 650B the runner starts running on the outer radius of the toroid 600A and will start feeling lighter. At that moment, the person moves to inner radius 606 where the pull is maximum.

Now referring to FIG. 12, according to various aspects and embodiments of the invention, represents the model for calculations related to producing an AG magnetic field within a toroid shaped structure.

a=6′

b=10′

1000 turns wound with 15 gauge copper wire flowing 3 Amps current the force on the box L=4′=1.21 m, W=1′=0.31 m, skin width of permalloy dw=10⁻⁴ m, are as follows:

At r=a=6′=1.83m, the innermost radius of the toroid.

F=279 Newton, equivalent to gravity force acting on mass 28.5 kg on the Earth

At r=8′=2.44m, the central radius

F=124 Newton, equivalent to gravity force acting on mass 12.7 kg

At r=b=10′=3.1m, at the outermost radius of the toroid

F=89 Newton, equivalent to gravity force acting on mass 9.1 kg

If we use 15-gauge wire for winding.

Wire diameter=0.072″

Will take space for 1000 turns=72″/12=6′. i.e., inner radius=6′ will accommodate 1000 turns in one-layer winding of the toroid.

Therefore, for the toroid:

a=6′

b=10′

The force acting on a box with permalloy shell (permalloy plating thickness on the swimsuit) 100μ=10⁻⁴ m around the box 4′ long and 1′ wide (representation of human) changes from 29 kg mass weight to 9 kg mass weight equivalent on the earth. This is 3 times force variation from innermost radius to outermost radius of the toroid.

In accordance with various aspects and embodiments of the invention, a magnetic field can be produced by a blunted nail shaped magnet or electromagnet embedded in the structure.

The preceding merely illustrates the various aspects and principles as incorporated in various embodiments of the invention. It will be appreciated that those of ordinary skill in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

Unless defined otherwise, all technical and scientific terms used herein have the same meaning as commonly understood by one of ordinary skill in the art to which this invention belongs. The verb couple, its gerundial forms, and other variants, should be understood to refer to either direct connections or operative manners of interaction between elements of the invention through one or more intermediating elements, whether or not any such intermediating element is recited. Any methods and materials similar or equivalent to those described herein can also be used in the practice of the invention. Representative illustrative methods and materials are also described.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates which may need to be independently confirmed.

Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein.

In accordance with the teaching of the invention a computer and a computing device are articles of manufacture. Other examples of an article of manufacture include: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

The article of manufacture (e.g., computer or computing device) includes a non-transitory computer readable medium or storage that may include a series of instructions, such as computer readable program steps or code encoded therein. In certain aspects of the invention, the non-transitory computer readable medium includes one or more data repositories. Thus, in certain embodiments that are in accordance with any aspect of the invention, computer readable program code (or code) is encoded in a non-transitory computer readable medium of the computing device. The processor or a module, in turn, executes the computer readable program code to create or amend an existing computer-aided design using a tool. The term “module” as used herein may refer to one or more circuits, components, registers, processors, software subroutines, or any combination thereof. In other aspects of the embodiments, the creation or amendment of the computer-aided design is implemented as a web-based software application in which portions of the data related to the computer-aided design or the tool or the computer readable program code are received or transmitted to a computing device of a host.

An article of manufacture or system, in accordance with various aspects of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

Accordingly, the preceding merely illustrates the various aspects and principles as incorporated in various embodiments of the invention. It will be appreciated that those of ordinary skill in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

Therefore, the scope of the invention, therefore, is not intended to be limited to the various aspects discussed and described herein. Rather, the scope and spirit of invention is embodied by the appended claims.

What is claimed is:

1. An apparatus for exercise, comprising: a toroid shaped enclosure, with electrically charged wire wound around the circular tube of the toroid enclosure, creating a magnetic field within the enclosure, wherein a person, wearing magnetic clothes, exercises within the magnetic field to experience an Artificial Gravity effect.

2. The apparatus of claim 1, wherein the enclosure is a partial toroid, including a treadmill for exercise.

3. The apparatus of claim 1 including a stair-stepper.

4. The apparatus of claim 1, wherein the enclosure includes four one-quarter toroids connected to make a continuous running track with a figure-eight (8) shape.

5. An apparatus to simulate, for a subject, artificial gravity with a magnetic field having a field gradient comprising:
a device selected from the group including:
an exercise equipment;
an enclosure; and
a toroid shaped running track;
in which magnetic field permeates; and
a means of creating inhomogeneous magnetic field, which produces magnetic field gradient (dB/dr), causing a force on a magnetic body in a desired direction,
wherein the subject is enclosed in a soft magnetic material,
wherein the subject experiences a force simulating the artificial gravity effects due to the magnetic field acting upon the soft magnetic enclosure.

6. The apparatus of claim 5 further comprising soft magnetic material clothing, which is worn by the subject, that interacts with a magnetic field producing a force to simulate a gravity effect upon the subject.

7. The apparatus of claim 5 further comprising a means of producing field gradient, wherein force is caused by the magnetic field and the field gradient in the enclosure in a desired direction.

8. The apparatus of claim 5, wherein force is caused by the magnetic field gradient produced by the inhomogeneous magnetic field of a toroid (field varying as 1/r) acting on a soft magnetic enclosure.

9. The apparatus of claim 5, wherein any exercise equipment is used to include the magnetic field and the field gradient, such as a stepper and elliptical.

10. An apparatus for exercise comprising magnetic field having a magnetic field gradient, wherein the magnetic field gradient is produced by a magnetic structure

11. The apparatus of claim 10, wherein the magnetic field gradient is produced by a blunted nail shaped magnet or electromagnet embedded in the structure.

12. The apparatus of claim 10 further comprising:
a toroid shaped running track;
wire wrapped around the track; and
a suit including a soft magnetic material,
wherein the wire is electrically charged to generate a magnetic field and a field gradient within the track,
wherein a runner wearing the suit experiences a gravity effect due to the magnetic field acting upon the suit.

13. The apparatus of claim 12 wherein the toroid shape includes four one-half segments of toroids connected into a continuous running track.

14. The apparatus of claim 10, wherein a segment of the track includes a treadmill having magnetic field and field gradient that is used to create a gravity effect upon the runner.

15. The apparatus of claim 14 wherein the treadmill includes means of creating a field gradient.

16. An apparatus comprising:
a chamber;
a magnetic shell shielding the chamber from radiation and stray magnetic fields; and
providing artificial gravity generator effecting a soft magnetic material clothing worn by an astronaut,
wherein the shell shields the astronaut wearing a soft magnetic material clothing or sleeping in a soft magnetic material sleeping bag within the chamber.

17. The apparatus of claim 16, wherein the shell includes a multilayer soft magnetic material.

18. The apparatus of claim 16, wherein the soft magnetic material clothing is multilayer magnetic material.
